(19) United States
(12) Patent Application Publication
(10) Pub. No.: US 2003/0217513 A1
(43) Pub. Date: Nov. 27, 2003

(54) Driving mechanism for a sliding door

(76) Inventor: Martin Fink, Waidhofen a.d. Ybbs (AT)

Correspondence Address: FRIEDRICH KUEFFNER, P.C., PATENT AND TRADEMARK ATTORNEY, 317 MADISON AVENUE, SUITE 910, NEW YORK, NY, 10017, US

(21) Appl. No.: 10/405,984

(22) Filed: Apr. 2, 2003

(30) Foreign Application Priority Data
Apr. 2, 2002 (AT) A 509 / 2002

(51) Int. Cl. E05F 11/00

(52) U.S. Cl. 49/360

(57) ABSTRACT

A driving mechanism for a door leaf (1) of a sliding door includes a pivoted lever (6) moved by a drive (4). The pivoted lever (6) is pivotal about a fixed pivoted lever shaft (5) extending perpendicularly onto the door leaf plane and carries an entraining device (8) which projects into a substantially vertical groove (2) connected to the door leaf and which can be moved with respect to the pivoted lever shaft (5) the entraining device (8) is arranged on a rotary handle (7) rotatably mounted on the pivoted lever (6) about a rotary handle shaft (17), and the rotary handle (7) is subject to the effect of a spring (9) which forces it in the direction corresponding to the closed end position of the door leaf (1).

### BACKGROUND OF THE INVENTION

1. Field of the Invention

The present invention relates to a driving mechanism for a door leaf of a sliding door, comprising a pivoted lever moved by a drive and which is pivotal about a fixed pivoted lever shaft extending perpendicularly onto the door leaf plane and carries an entraining device which projects into a substantially vertical groove connected to the door leaf and which can be moved with respect to the pivoted lever shaft. The sliding door can be an outer door, inner door or pocket door, in particular for rail vehicles.

2. Description of the Related Art

There are a range of installation situations for doors of this type in rail vehicles, in particular in underground trains, such as the London underground, in which it is not possible to accommodate the driving mechanism for the door above the door in the vehicle frame, as otherwise conventional. In these cases it has proven to be successful to use an actuating lever pivotal about approximately 180° and which is anchored, together with its drive, in the vicinity of the floor next to the door, the lever engaging with a suitable engagement element in a groove provided at least substantially vertically in or on the door. If the lever is pivoted accordingly from one end position into the other the engagement element describes a circle, preferably substantially a semicircle, and in the process displaces the door in the horizontal direction about the diameter of the engagement element with respect to the pivot axis of the lever. Very extensive opening of the door is thus achieved and owing to the end positions of the lever in an at least approximately horizontal direction, automatic self-locking, which means opening of the door during travel is not possible in the event of manipulation of the closed door.

In order to give passengers the possibility of freeing trapped articles or body parts, in doors of this type it is stipulated that the main closing edge of the door also has to open in the closed position of the door drive by a predetermined amount. In the prior art this problem is solved in that the pivoted lever is designed so as to be longitudinally adjustable, for example telescopic, and is subject to the force of a spring which presses it into its elongated position. To allow reliable closing the spring also has to still be sufficiently pretensioned in this longest position of the pivoted lever in order to close the door tightly. However, this means that when the door is opened in the predetermined range the opening force increases owing to the increasing compression of the spring and therefore partial opening of the door and freeing of the trapped articles or body parts is made more difficult.

A further very considerable drawback of the known solution is that the longitudinal movement between the assembled parts of the pivoted lever mounted on or in one another can be constructed sufficiently stably and protected from dust that the construction achieves the required minimum service life between successive servicings only with difficulty and great expenditure. It should be taken into account that current service intervals of several years are prescribed. In addition there is the fact that assembly of the driving mechanism next to the door in the lower region of the carriage, between the outer wall and the seats arranged in front of it presents an additional challenge (even in the absence of frost) owing to constant soiling.

### SUMMARY OF THE INVENTION

The aim of the present invention is to indicate a device of the type mentioned at the outset in which the above-stated drawbacks do not occur and which, in particular, is insensitive to soiling and wear and also has a passenger-friendly opening force characteristic over the emergency opening range.

According to the invention these aims are achieved in that the pivoted lever is rigid in design and at its free end carries, rotatably, a rotary handle which can be rotated between two positions with respect to the pivoted lever, and in that the rotary handle is forced into the end position with respect to the pivoted lever by a spring, the end position corresponding to the closed end position of the door.

In one configuration the spring is a helical spring designed as a compression spring and acts with its one end in the bearing region of the pivoted lever and with its other end on the rotary handle.

### BRIEF DESCRIPTION OF THE DRAWING

The invention will be described in more detail hereinafter with reference to the drawings, in which:

FIG. 1 shows a driving device according to the invention in the closed position of the door,

FIG. 2 shows the device of FIG. 1 with the door pressed open over the emergency opening range,

FIG. 3 shows the device of FIG. 1 in the open position of the door and

FIG. 4 shows a comparison between conventional systems and the drive according to the invention of the force required to open the door in the emergency opening range.

### DETAILED DESCRIPTION OF THE INVENTION

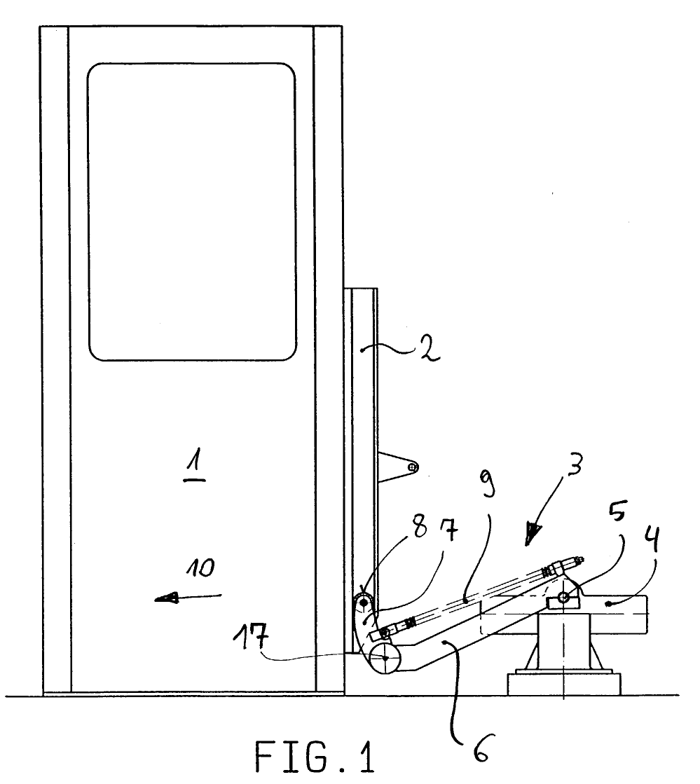

FIG. 1 shows purely schematically and without details how the actual guidance of the door or even only the door frame is to be dealt with, a door leaf 1 with a movement rail 2 which in the region of its auxiliary closing edge, therefore in the vertical direction, is connected so as to be fixed to the door leaf. A driving device according to the invention designated by 3 in its entirety consists of an actual drive 4, in the example shown a dual-acting pneumatic cylinder, which can of course be replaced by an electric drive or the like and which has a pivoted lever 6 rotatable about its pivoted lever shaft 5. A rotary handle 7, on the end of which an entraining device 8, for example a roller, is arranged which engages in the guide rail 2, is rotatably mounted on the free end of the pivoted lever 6 between two end points. In the illustrated embodiment the rotary handle 7 is subject to the force of a spring 9 which acts at one end close to the pivoted lever shaft 5 on the pivoted lever 6 and at the other end on the rotary handle 7. In the illustrated view the spring 9 attempts to rotate the rotary handle 7 counterclockwise. In this manner the door leaf 1 is subject to a closing force in the direction of the arrow 10.

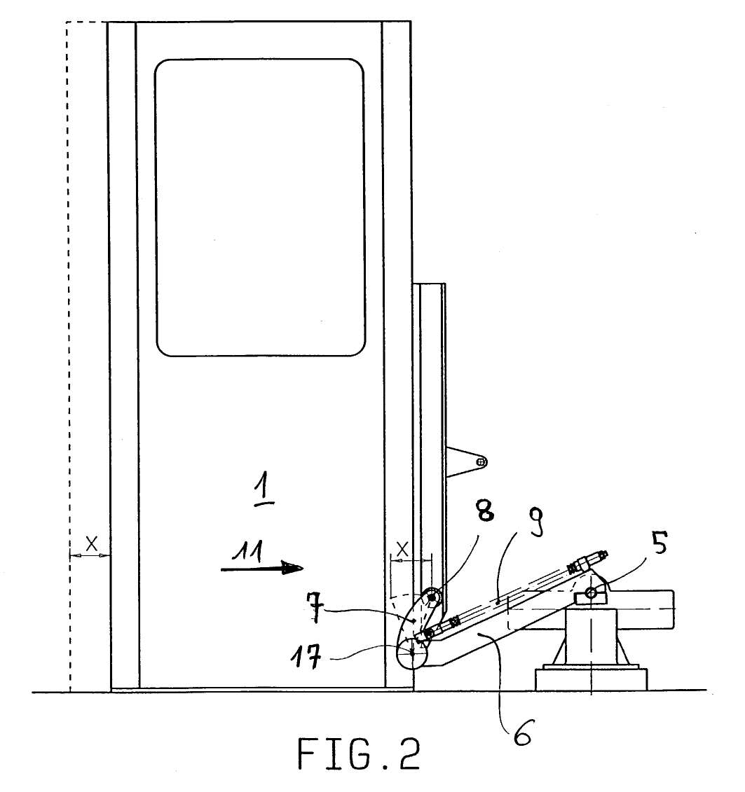

If, accordingly, for whatever reasons partial opening of the door by the distance X (FIG. 2) is desired or necessary the rotary handle 7 can be rotated clockwise counter to the force of the spring 9, so the door leaf 1 can be displaced in the direction of opening by the predetermined distance X. Further opening is not possible as the rotary handle 7 abuts against a stop (not shown) in this region and the pivoted lever 6 is loaded with a moment counterclockwise, and therefore in its direction of closure, in the event of any further effect of force in the direction of the arrow 11.

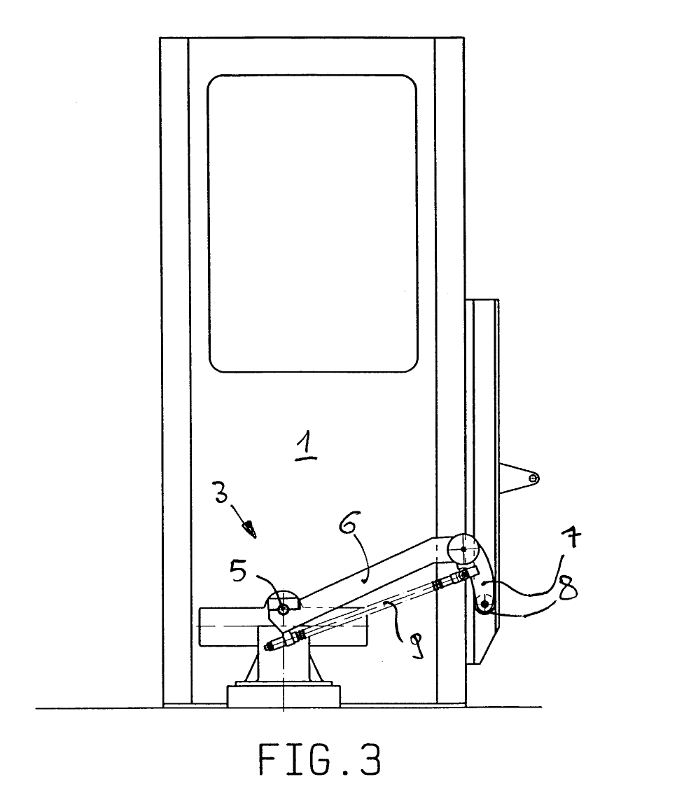

For the sake of completion FIG. 3 shows the door leaf 1 and the driving device 3 according to the invention in the position corresponding to the open door. The pivoted lever 6 is pivoted about almost 180° with respect to the closed position, the compression spring 9 forces the rotary handle 7 in the counterclockwise direction with respect to the pivoted arm 6, so the entraining device 8 arrives in the position furthest to the right with respect to the pivoted lever shaft 5 and in which it has the greatest distance from the pivoted lever shaft 5, and the door is displaced to the greatest extent with respect to the closed position.

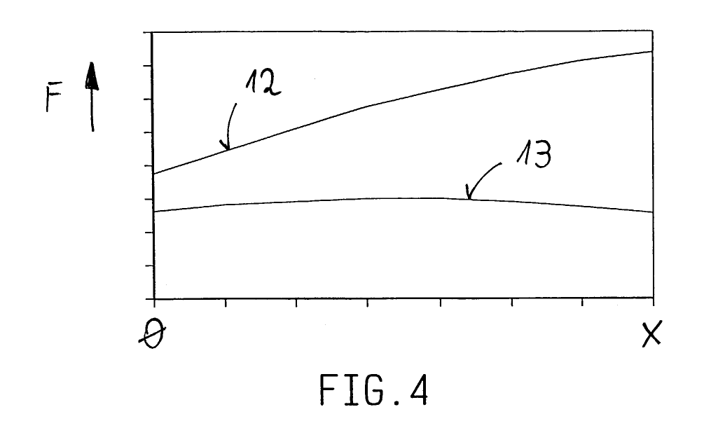

FIG. 4 shows the force F required to move the door leaf 1 in the direction of the arrow 11 over the distance X (FIG. 2) in conventional door drives with the curve 12 and in the door drive according to the invention with the curve 13. The opening force remaining practically constant over the entire opening distance X is achieved owing to the reduction in the effective lever arm of the line of action of the compression spring 9 with respect to the rotary handle shaft 17 of the rotary handle 7 on the pivoted lever 6, discernible from the comparison of FIG. 1 and FIG. 2. Owing to this reduction in the effective lever arm it is possible to compensate the compression force of the tension spring 9 which increases over the spring excursion.

The invention is not limited to the illustrated embodiments, rather can be changed and modified in different ways. Therefore, it is possible to use a torsion spring, instead of the compression spring 9, in the joint in the region of the rotary handle shaft 17 between the pivoted lever 6 and the rotary handle 7 if there is sufficient space in the direction of the rotary handle shaft 17 (parallel to the pivoted lever shaft 5, therefore perpendicularly to the drawing plane). If it is desirable and there is sufficient space, the rotary handle 7 can of course be extended beyond the rotary handle shaft 17 and the compression spring 9 which then acts on the rotary handle 7 beyond the rotary handle shaft can be constructed as a tension spring, and this possibly makes the provision of a stabilising rod in the interior of the spring superfluous. In this case the spring can possibly be arranged in a thin, telescopic or harmonica-like jacket tube which makes the admission of dirt difficult.

It has already been mentioned at the outset that the drive does not have to be pneumatic, rather any drive can be used here which is capable of providing the pivotal movement of the pivoted lever 6.

It is of course possible to provide an entire range of additional functions, thus an emergency door unlocking device, which allows the pivoted lever 6 to be brought manually into the open position in an emergency, and suchlike, the essential aspect here always being that the aims mentioned at the outset are achieved owing to the replacement of the telescopic pivoted lever with a rigid pivoted lever and a rotary handle rotatably fastened thereto.

The invention therefore relates to the driving mechanism of a sliding door which is securely locked in the closed position of the door by a top dead centre mechanism, i.e. cannot be opened owing to the effect of force on the door. As accordingly in many countries it is legally prescribed for safety reasons that it must be possible for a user to press open the door by a small portion even in the closed state in order to be able to free jammed articles (umbrellas, briefcases, fingers), it is known in the prior art to construct the lever of the drive mechanism, which ultimately acts directly on the door leaf, so as to be telescopic and to press it constantly into the extended position owing to a spring. This has the above-mentioned drawbacks which are to be avoided according to the invention.

This problem is solved in that the known telescopic rod is replaced by a rigid rod, in that this no longer acts directly on the door leaf but carries a rotary handle connected to the door leaf which accordingly is in turn forced by a spring into the position corresponding to the “closed position” of the door or door leaf. The advantages of using a pivotal construction compared with the telescopic construction, in particular in different configurations, have been described in detail in the description.

I claim:

1. Driving mechanism for a door leaf (1) of a sliding door, comprising a pivoted lever (6) moved by a drive (4) and which is pivotal about a fixed pivoted lever shaft (5) extending perpendicularly onto the door leaf plane and carries an entraining device (8) which projects into a substantially vertical groove (2) connected to the door leaf and which can be moved with respect to the pivoted lever shaft (5), characterised in that the entraining device (8) is arranged on a rotary handle (7) rotatably mounted on the pivoted lever (6) about a rotary handle shaft (17), and in that the rotary handle (7) is subject to the effect of a spring (9) which forces it in the direction corresponding to the closed end position of the door leaf (1).

2. Driving mechanism according to claim 1, wherein the entraining device (8) is a roller.

3. Driving mechanism according to claim 1, wherein the spring (9) is a compression spring which acts with its one end on the pivoted lever (6), preferably near the pivoted lever shaft (5), and with its other end on the rotary handle (7) between the rotary handle shaft (17) and the entraining device (8).
